(19) United States
(12) Patent Application Publication
(10) Pub. No.: US 2007/0073601 A1
(43) Pub. Date: Mar. 29, 2007

(54) Floor plan finance serial number tracking system and method

(76) Inventor: Corey L. Holton, Portland, OR (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/522,295

(22) Filed: Sep. 15, 2006

Related U.S. Application Data
(63) Continuation-in-part of application No. 11/488,446, filed on Jul. 17, 2006.
(60) Provisional application No. 60/718,176, filed on Sep. 15, 2005.

(51) Int. Cl. G06Q 10/00

(52) U.S. Cl. 705/28

(57) ABSTRACT

A business management computer program allows a business owner to track inventory items that are being financed by serial number. According to one aspect of the present invention, This process typically includes defining the a floor plan, tagging items on purchase orders, receiving the inventory, assigning the serial number to the inventory item. This allows the business owner to track items for a given floor plan by viewing all floor financed inventory on one screen and provides information on how long until the interest payments on each inventory item starts

### PRIORITY CLAIM

This application is a Continuation-in-Part of U.S. patent application Ser. No. 11/488,446,filed on Jul. 17, 2006and claims priority from U.S. Provisional Patent Application No. 60/718,176,filed Sep. 15, 2005,which is incorporated herein by reference.

### TECHNICAL FIELD

The present invention relates generally to computer programs, and more specifically to business computer programs for performing various tasks associated with running a business.

### BACKGROUND OF THE INVENTION

Businesses sometimes have a need to finance inventory purchases for items they want to bring into stock and display on their showroom floors, use as demo models, or resell immediately. These items that are financed are tracked by serial number to keep an accurate accounting of them. Floor Finance plans require payments as these specific serial numbered items are sold or as the floor plan finance plan dictates, sometimes from an outside financing company. Therefore, an accurate status of each serial numbered item is of great importance to a business owner. A business owner needs to be acutely aware of the serial numbered inventory items that are in stock, in stock and sold, or delivered to the customer and financed and if those items are accruing interest charges. Also, of great importance is what inventory the business owner has financed and is waiting delivery of from the supplier.

In business generally, there is a need to track certain inventory items by serial number. Serial Number tracking is important to many different functions of the business. Keeping high value serial numbers in stock for too long increases expenses, ties up capital and erodes profit margins. Once a high value serialized inventory item has been sold, a business can track that item through its usable life by the serial number. They can view the maintenance history and warranty of an item allowing them to properly maintain, warranty and invoice for services rendered. There is a need for businesses to properly track an inventory item by serial number to minimize cost and maximize internal efficiency.

There is a need for a tracking system that identifies floor financed items and other items by serial number, tracks that item in inventory, and tracks when the interest starts. This will enable business owners to minimize the finance charges associated with financed stock items.

### SUMMARY OF THE INVENTION

According to one aspect of the present invention, a business management computer program allows a business owner to track inventory items that are being financed by serial number. According to one aspect of the present invention, a process includes defining a floor plan, tagging items on purchase orders, receiving the inventory, and assigning the serial number to the inventory item. This allows the business owner to track all inventors items for a given floor plan by viewing all floor financed inventory on one screen and provides information on how long until the interest payments on each inventory item starts.

According to another aspect of the present invention, a program functions as a single user interface to allow a business to track serialized inventory items and manage them on a single screen (user interface). The program allows a businesses to properly track all information related to a serialized inventory item allowing purchasing to know what they bought and when, management to know what is in stock and how long it has been on hand, management to be able to discount specific serial numbers in order to motivate sales to sell them quickly, store managers to track what is on their floor, store managers to reserve serial numbers as Floor Models for a certain period of time and then release them for sale, Sales to know what is in stock and what is available to sell or not sell, Sales to manage sales holds on specific serial numbers for customers who have a high desire to purchase the product, Sales and management to reserve a serial number for a customer when a commitment is made to purchase the serialized inventory item, Delivery and Fulfillment to know which item to give to which customer, Sales to know what is coming into stock that Purchasing as Ordered. Traditionally, in other software packages, each point listed about would be a specific report or specific screen that would require the user to go to multiple places to search for all information related to a serialized inventory item.

### BRIEF DESCRIPTION OF THE DRAWINGS

FIG. 1 is a functional block diagram of a computer system including processing circuitry for executing a business management computer program that implements a Floor Plan Finance Serial Number Tracking process according to one embodiment of the present invention.

FIG. 2 describes a process executed by the business management computer program of FIG. 1 to track floor plan financing by serial number according to one embodiment of the present invention.

FIGS. 3-7 are screens of a Floor Plan Finance Search Screen rendered by the business management computer program of the according to one embodiment of the present invention.

FIG. 7 describes a process executed by the business management computer program of FIG. 1 to track serial numbers of inventory items according to one embodiment of the present invention.

FIGS. 8-12 illustrate screens rendered by the business management computer program of FIG. 1 while executing the process of FIG. 7 according to one embodiment of the present invention

### DETAILED DESCRIPTION OF PREFERRED EMBODIMENTS

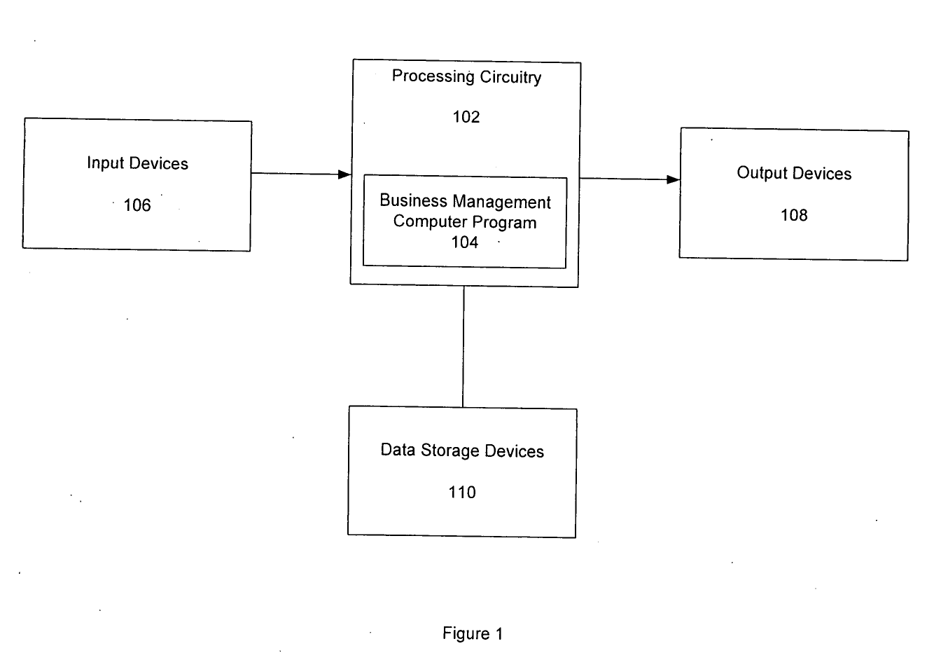

FIG. 1 is a functional block diagram of a computer system 100 including processing circuitry 102 for executing a business management computer program 104 that that executes a serial number tracking process according to one embodiment of the present invention. The computer system 100 includes one or more input devices 106, such as a keyboard or a mouse, coupled to the processing circuitry 102 to allow an operator to interface with the computer system. Typically, the computer system 100 also includes one or more output devices 108 coupled to the processing circuitry 102, such output devices typically including a printer and a video terminal. One or more data storage devices 110 are also typically coupled to the processing circuitry 102 to store data or retrieve data from external storage media (not shown). Examples of typical storage devices 110 include hard and floppy disks, tape cassettes, compact disk read-only (CD-ROMs) and compact disk read-write (CD-RW) memories, and digital video disks (DVDs).

In the present description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments and components of such embodiments are within the scope of the present invention. Embodiments including fewer than all the components of any of the respective described embodiments may also be within the scope of the present invention although not expressly described in detail below. Finally, the operation of well known components and/or processes has not been shown or described in detail to avoid unnecessarily obscuring the present invention.

An integrated system for providing comprehensive functionality for all business processes from the generation of leads via marketing efforts through the preparation of financial statements containing entries for sales of products or services to such leads is set forth in U.S. patent application Ser. No. 11/185,103entitled LEAD-TO-INCOME STATEMENT METHOD AND SYSTEM, which was filed on Jul. 19, 2005and which is incorporated herein by reference. The business management computer program 104 may be part of the integrated system or program described in this application according to one embodiment of the present invention.

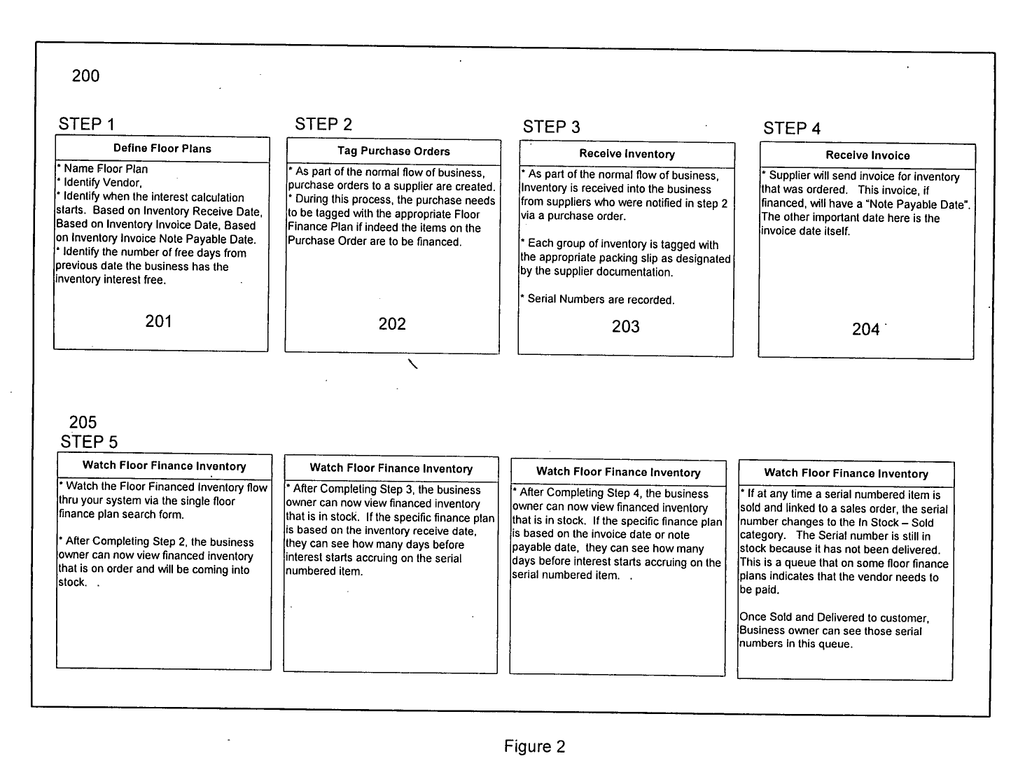

FIG. 2 illustrates a process in which financed inventory items are tracked by serial number. First, a floor plan is defined in step 201 of the process. A floor plan is an agreement between a vendor and a business to finance inventory purchases. This includes identifying the vendor that the inventory will be supplied from. Then, when the interest calculation starts is identified. This can be based on Inventory Receive Date, Inventory Invoice Date, or Inventory Invoice Note Payable Date.

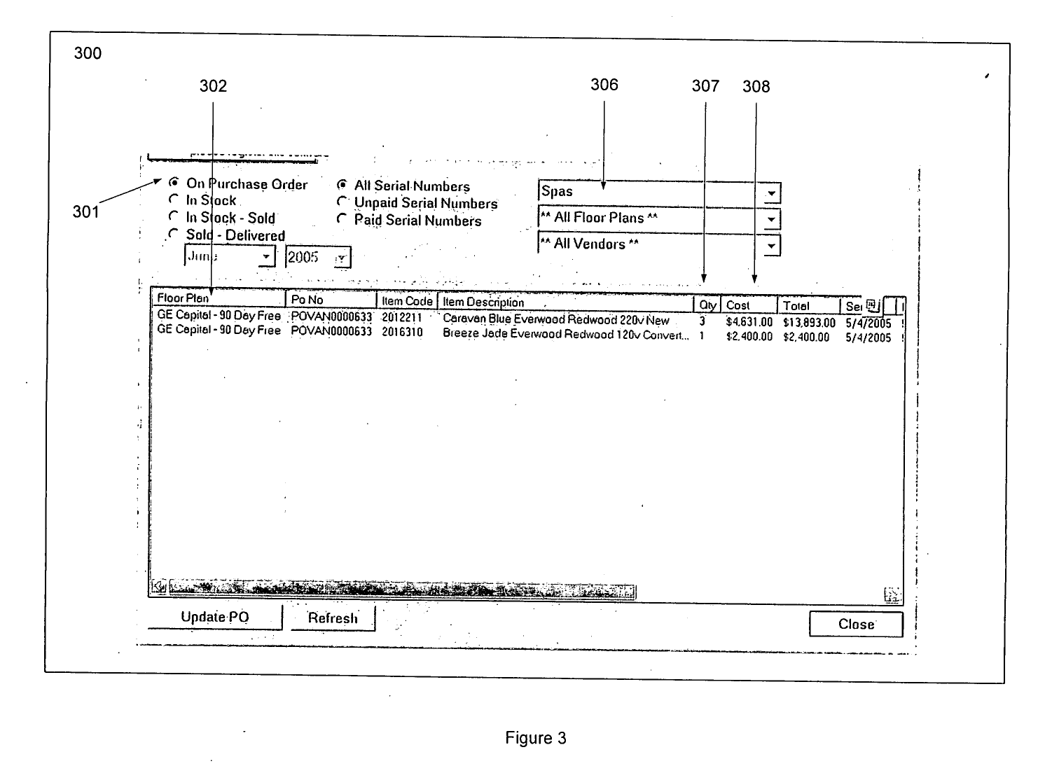

As part of the normal flow of business, purchase orders to a supplier are created in step 202. When a purchase order with an item on it that will be floor financed is created, the inventory item is tagged with the floor plan defined in step 201. Tagging an inventory item means associating a specific purchase order for that inventory item with an agreed upon finance plan. When the inventory is received, the serial number is recorded in step 203. The business owner will decide how they want to track their Floor Financing. This can be based on Inventory Receive Date, Inventory Invoice Date, or Inventory Invoice Note Payable Date. Now the business owner can track their Floor Financing via a single floor plan search form 300 as shown in FIG. 3. The business owner can now track the inventory items of the defined floor plan. More specifically, the owner may view financed inventory that is on order and will be coming into stock in step 205. If the specific finance plan is based on the inventory receive date, they can see how many days before interest starts accruing on the serial numbered item. If the specific finance plan is based on the invoice date or note payable date, they can see how many days before interest starts accruing on the serial numbered item. If at any time a serial numbered item is sold and linked to a sales order, the serial number changes to an In Stock-Sold category. The Serial number is still in stock because it has not been sold. This is a queue that on some floor finance plans indicates that the vendor needs to be paid. Once Sold and Delivered to customer, a Business owner can see those serial numbers in this queue.

FIG. 3 Illustrates the Floor Plan Search Form 300 rendered by the business management program 104. By Filtering via “On Purchase Order” 301 a business owner can see all items that are on Purchase Orders with the Supplier that have not arrived yet. Cost 308, Quantity 307 and the specific Floor Plan 302 are available for viewing to determine the impact of possible future floor plan finance charges. Filters are available 306 to narrow the search down by Inventory Product lines, Specific or all Floor Plans, or by Vendor.

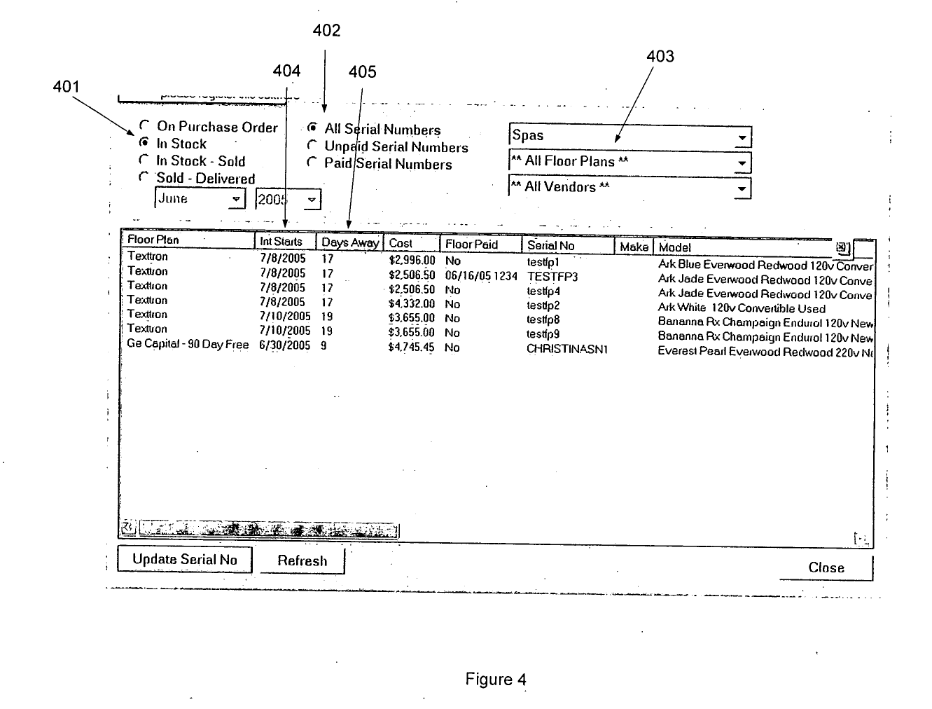

Referring to FIG. 4, when filtering by “In Stock” 401 a business owner can see all Floor Plan Finance Serial Numbered Items that are physically located at one of their stock sites or showroom floors. The list displays the day that interest will start accruing 404 and how many days away that is 405. A business owner can use these dates to motivate the sales staff to sell specific items before they start incurring finance charges and decreasing the profit margin. Filters 402 are available to narrow the search down by All Serial Numbers, Unpaid Serial Numbers, or Paid Serial Numbers. The Product Line, Specific Floor Plan, and Vendors can be filtered as well via filters 403.

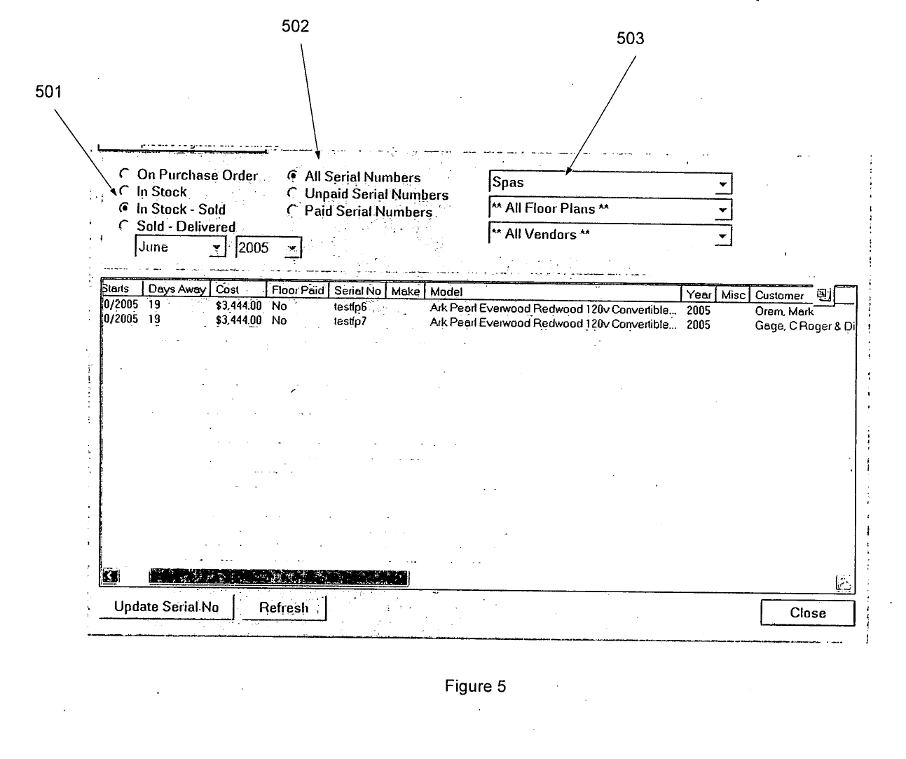

Referring not to FIG. 5, when filtering by “In Stock-Sold” 501 a business owner can see all Floor Plan Finance Serial Numbered Items that are physically located at one of their stock sites or showroom floors, but have been sold to a customer. Typically, these serial numbered items require a period of time between moment of sale and customer pick up or delivery. This is an important time in the floor financing in that some floor finance plans require payment on the particular item at time of sale. This gives the business owner great tracking ability so that they do not incur any late fees or extra finance charges for paying floor finance charges late. Filters 502 are available to narrow the search down by All Serial Numbers, Unpaid Serial Numbers, or Paid Serial Numbers. The Product Line, Specific Floor Plan, and Vendors can be filtered 503 as well.

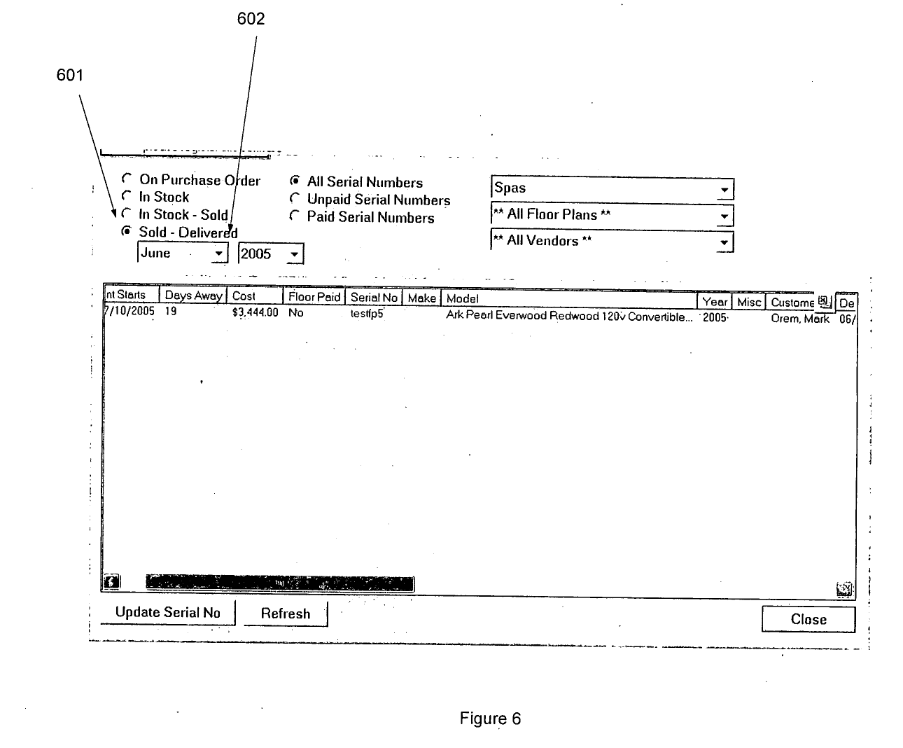

As shown in FIG. 6, when filtering by “Sold-Delivered” filter 601 a business owner can see all Floor Plan Finance Serial Numbered Items that are not in their inventory anymore. These serial numbers have been delivered to the customer and the customer has ownership and possession. The business owner has the ability to go back in history as far they want by using the month and year filters that are enabled once they choose to filter through the Sold-Delivered filter 601.

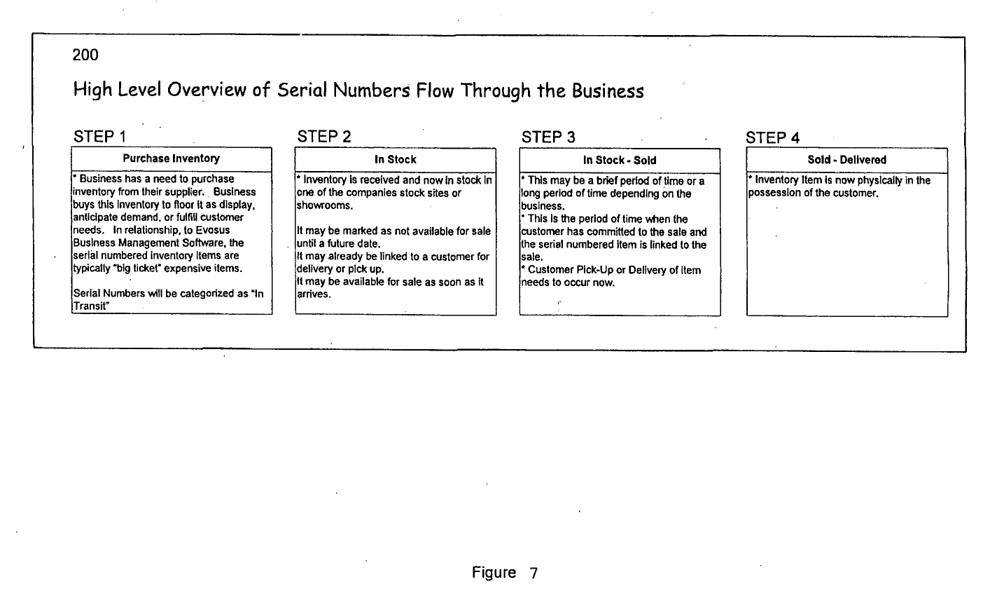

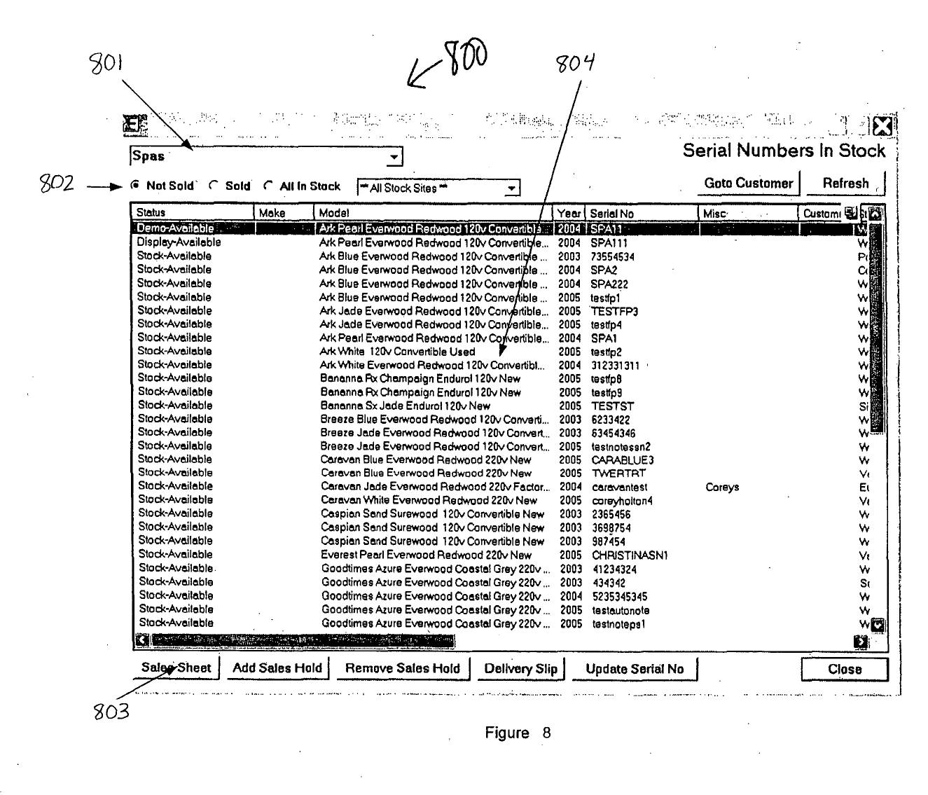

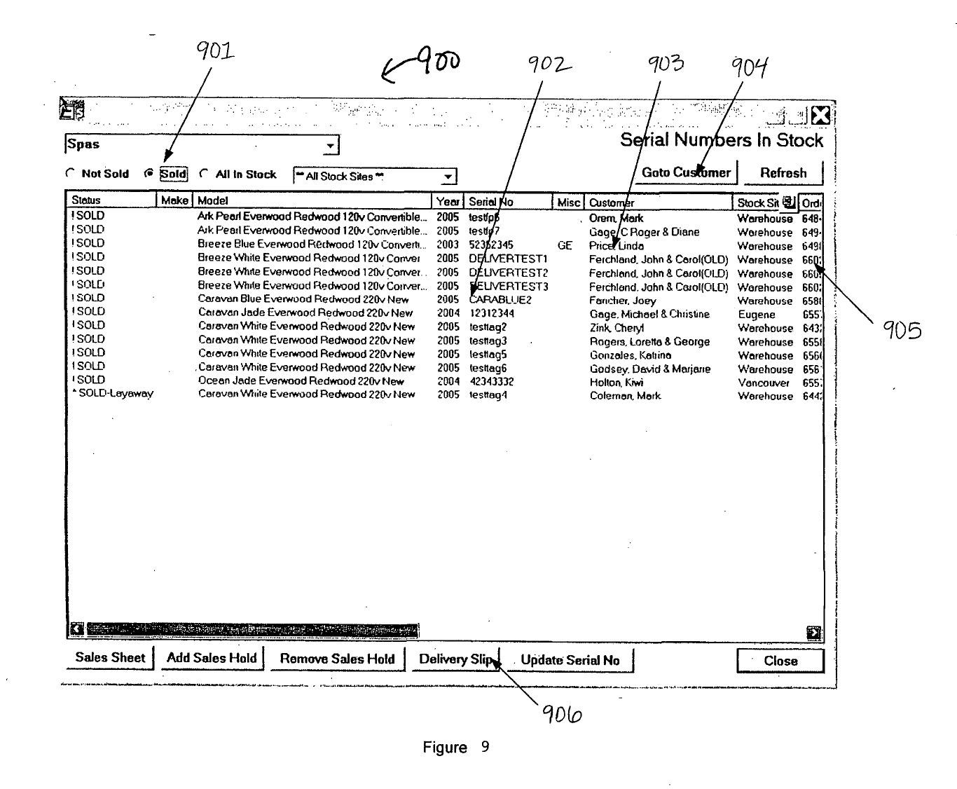

FIG. 7 is a high level overview of a process 200 through which a serial number flows through a business during execution of the program 104 of FIG. 1 according to one embodiment of the present invention. The program 104 allows the management of serial numbers through one screen 800 as depicted in FIG. 8. This screen 800 is called Serial Numbers in Stock screen and from this screen all serialized inventory items can be managed. The list of items can be filtered by using a Not Sold, Sold, or All In Stock radial buttons 802. The Serial Numbers in Stock Screen 800 3 list of items contains the serial numbers for each item. A status field indicates whether the item is available for sale or not and a Make/Model/Year/Misc field describes the item corresponding to the Serial Number. Scrolling to the right allows a user to see Stock Site Location, Age (how many days in inventory), available for sale date, and received date, none of which are shown in FIG. 8. If filter radial buttons 802 are set to Sold 801, the screen 800 allows a user to view all serial numbers that are linked to sales orders that are waiting for delivery. Referring to FIG. 9, Double Clicking a serial number 902 that is linked to a sale will open the sales order (Not Shown). An Order ID 905 is available for viewing also as well as Expected Delivery Date by scrolling to the right. With this information, sales people can make good decisions when swapping serial numbers for a new customer who is willing to take delivery today and then purchasing another serial number for a waiting customer. A Hot Link 904 for going to a customer profile of the customer who is waiting for the serial number is provided. A Delivery Manager portion of the program 104 can print a delivery slip for the order with serial number documentation via a button 906.

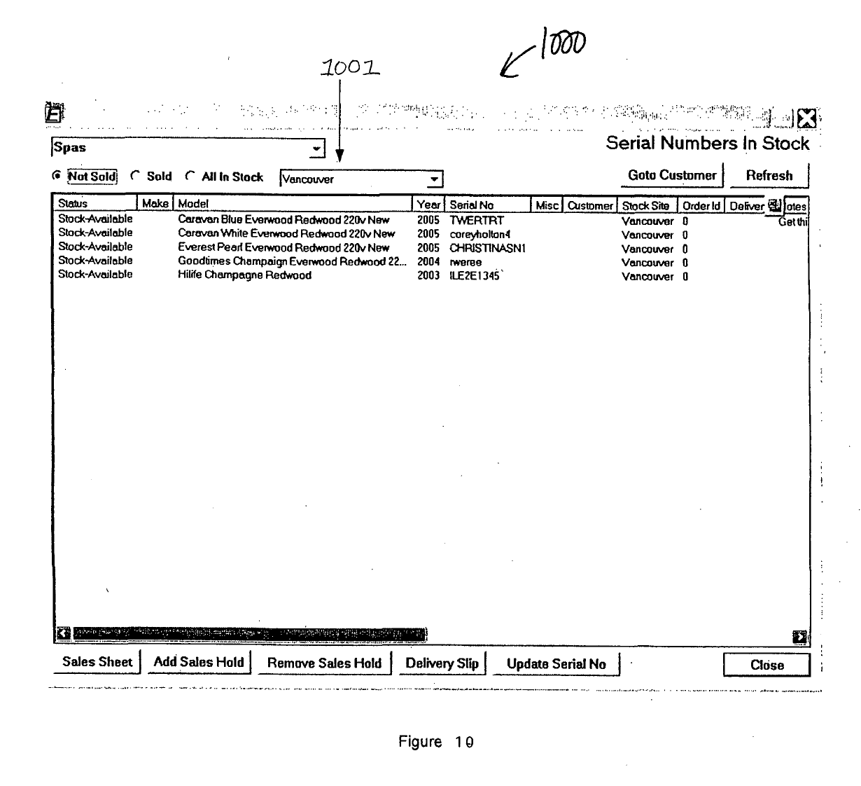

To filter the Serial Numbers in Stock by stock site, as shown in a stock screen 1000 of FIG. 10 a user of the program 104 can click on a stock site filter 1001. This filter only shows serialized inventory items associated with a specific location within the business such as a retail store or warehouse (Vancouver Store Shown as an example in the figure).

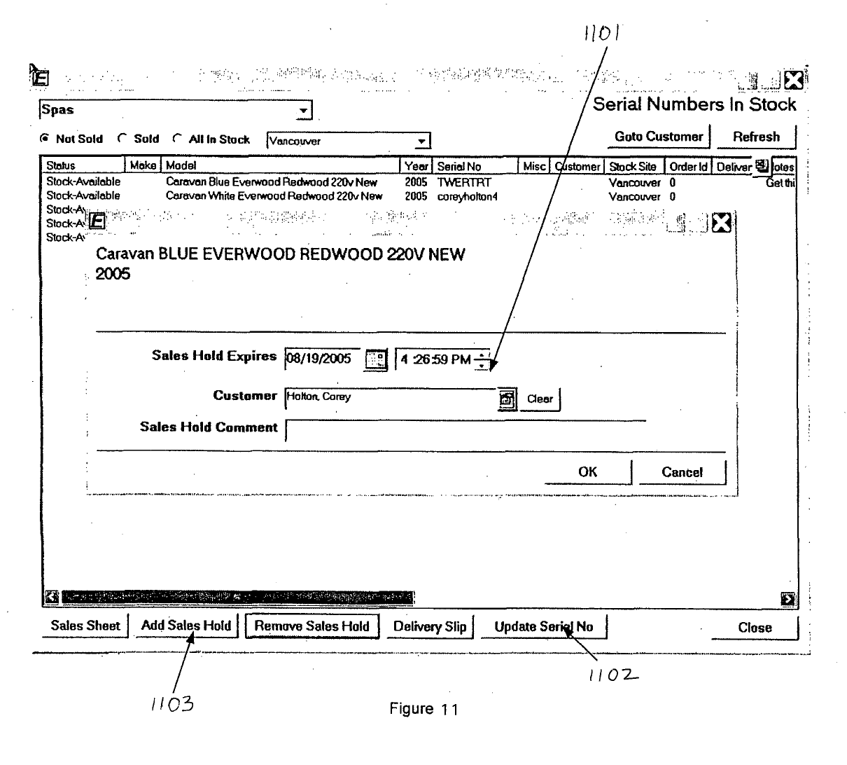

Referring now to FIG. 11, by selecting an add sales hold button 1103 a sales person can indicate that they have a hot prospect who is interested in a particular inventory item. A sales hold puts the serialized inventory item in a temporary hold status. Sales hold can be linked to a specific customer and be set to expire at the sales person's discretion. The program 104 will automatically remove the hold once it expires.

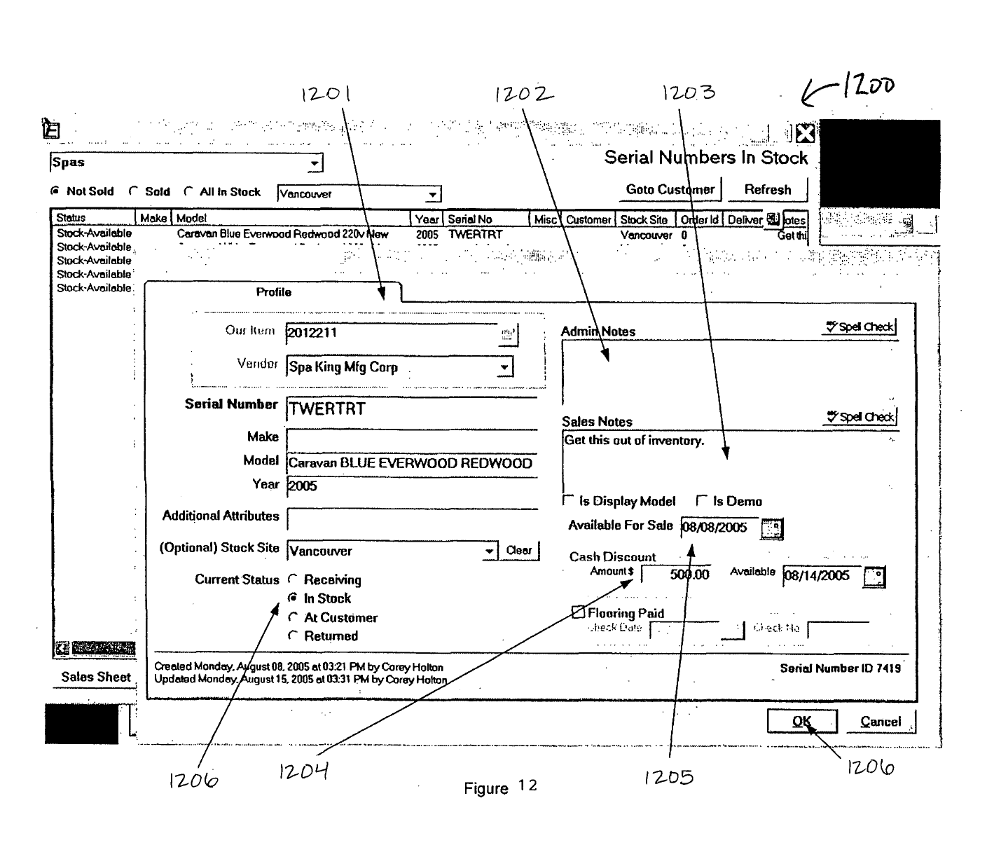

FIG. 12 illustrates a screen 1200 in which a serial number's specific data is entered. A user of the program 104 reaches this screen 1200 by clicking on an Update Serial Number button 1102 in FIG. 11. A user with the appropriate security settings can update the serial number right from the In Stock queue 1201. Administrative notes about purchase for finance charges can be stored 1202 and sales Notes can be communicated to staff here about this particular serial number 1203. Cash Incentives 1204 can be set here by management if they want to get this item sold quickly. Serial Numbers can be marked so that they automatically become available for sale on a specific date 1205. The current status of the serialized item can be changed using current status radial buttons 1206. Once a user of the program 104 is done reviewing or editing the data of the serialized inventory item, a window containing the screen 1200 can be closed using an OK button 1206.

Even though various embodiments and advantages of the present invention have been set forth in the foregoing description, the above disclosure is illustrative only, and changes may be made in detail and yet remain within the broad principles of the present invention. Therefore, the present invention is to be limited only by the appended claims.

What is claimed is:

1. A method of tracking inventory items that are being financed via serial number, the method comprising:
defining a floor plan for the items to be tracked;
tagging items on purchase orders;
receiving inventory corresponding to the items to be tracked;
assigning a serial number to each inventory item; and
tracking the inventory items of the defined floor plan.
